(19) United States
(12) Patent Application Publication
(10) Pub. No.: US 2008/0191449 A1
(43) Pub. Date: Aug. 14, 2008

(54) Trailer Vehicle Coupling Safety Aids

(76) Inventor: John Paul Standen, Isle of Wight (GB)

Correspondence Address: JACKSON WALKER, L.L.P., 112 E. PECAN, SUITE 2400, SAN ANTONIO, TX, 78205, US

(21) Appl. No.: 11/887,491

(22) PCT Filed: Mar. 31, 2006
(86) PCT No.: PCT/GB2006/050071

§ 371 Date: Oct. 29, 2007

(30) Foreign Application Priority Data
Apr. 1, 2005 (GB) 0506610.5

(51) Int. Cl. B60D 1/36; B62D 53/12

(52) U.S. Cl. 280/427; 280/477

(57) ABSTRACT

A system for monitoring the coupling of a tractor to a trailer of an articulated road vehicle, the tractor mounting a hitch assembly (7) for coupling to a king pin (9) downwardly depending from the underside of the trailer (10), comprises a sensor (14) producing an electrical signal proportional to the vertical distance between the hitch assembly and the underside of the trailer, and indicator means (16) connected to the sensor for providing an indication of the vertical distance.

### FIELD OF THE INVENTION

This invention relates to an articulated vehicle trailer coupling position detector and locking detector.

### BACKGROUND OF THE INVENTION

Conventionally, the tractor and trailer of an articulated road vehicle are coupled together through a “fifth-wheel” arrangement in which a king pin extending downwardly from the underside of the trailer is engaged with and locked into a coupling on the tractor. The coupling typically includes a hitch plate having an opening or throat in its rearward end to guide the king pin into the coupling socket at the centre as the tractor is reversed into position beneath the parked trailer. Once the king pin is in position in the coupling socket, it is locked automatically as the mechanism closes around it. The driver normally checks this has happened by engaging 1^{st} gear and pulling against the trailer, as the trailer brakes have not been released by the air line at this stage the vehicle should not move.

The coupling operation requires some precision, firstly to ensure that the king pin enters the throat centrally and at the right height, and secondly to ensure that the king pin is engaged and locked into the coupling socket. If the king pin is too high relative to the hitch plate, it is possible for it to miss the socket entirely and to land in front of the hitch plate when the trailers temporary supporting legs are raised. This can give the impression to the operator that the trailer is correctly coupled when it is not. When the tractor is driven forwards, the trailer follows, but as soon as the vehicle seeks to negotiate a corner, the trailer can become detached, with damaging and potentially dangerous consequences.

Even if the king pin is correctly located in the coupling socket, failure of the locking mechanism to operate correctly can lead to detachment of the trailer from the tractor in use Again, the consequences of this will be at least substantial damage to the trailer, and may lead to a road traffic accident involving other vehicles.

It is therefore highly desirable to ensure that the coupling of the tractor to the trailer is carried out correctly on every occasion.

EP-A-1 295 783 discloses a system for monitoring the fifth wheel hitch on a tractor and trailer combination. Three sensors are provided on or near the fifth wheel assembly on the tractor. A first sensor detects rotation of the hitch plate about a horizontal axis as the king pin moves over it, a second sensor detects the presence of the king pin end in the socket, while a third sensor detects the locking mechanism when it is in the locked position. This arrangement is clearly advantageous over the conventional arrangements in providing confirmation of the correct positioning of the king pin, it still requires the tractor driver to position the tractor accurately with respect to the trailer. If, for example, the hitch plate is too low relative to the king pin or the alignment of the tractor relative to the longitudinal axis of the trailer is incorrect, the driver is given no indication of this.

### SUMMARY OF THE INVENTION

Accordingly, the present invention provides a system for monitoring the coupling of a tractor to a trailer of an articulated road vehicle, the tractor mounting a hitch assembly for coupling to a king pin downwardly depending from the underside of the trailer, the system comprising a sensor producing an electrical signal proportional to the vertical distance between the hitch assembly and the underside of the trailer, and indicator means connected to the sensor for providing an indication of the vertical distance.

In one configuration, the system comprises a pair of sensors mounted on the tractor and laterally spaced one from the other relative to the direction of travel of the vehicle. The sensors are preferably located to the rear of the hitch assembly on the tractor, one on each side of the centre-line of the tractor. Additional sensors are provided on the tractor outwardly and rearwardly of the first sensors.

In an alternative configuration, the system has first and second sensors mounted on the centre line of the tractor, the first located at the rearmost part of the tractor, in order to give the earliest possible detection of passage underneath the trailer, and the second just in front of the hitch assembly. In this way, a warning can be provided when the rear end of the tractor first moves beneath the front end of the trailer, and a further warning can be provided when the hitch assembly reaches the desired position beneath the trailer.

The indicator means preferably include a controller arranged to compare the respective signals and to output signals to an indicator device mounted in the tractor adjacent to the driver thereof to provide visual and/or audible indications when either of the following conditions applies:

a) the said vertical distance is not within a predetermined range; or

b) the difference between the vertical distances detected by the two sensors is greater than a predetermined value.

The or each sensor preferably comprises an ultrasonic transmitter arranged to transmit acoustic energy upwardly and an associated ultrasonic detector to detect the energy reflected back from a surface above the sensor. By determining the time taken for the ultrasound to travel to the surface and back, a measurement of the distance can be obtained. Ultrasonic sensors are preferred because they are less affected than optical devices by the build-up of dust and dirt in the area of the fifth wheel. The transmitter and receiver may be integrated into a single unit, or they may be separate devices spaced one from the other.

The ultrasonic sensors may transmit brief pulses of acoustic energy, with sufficient time between adjacent pulses to allow for detection of the reflected signal. Alternatively, the sensors may transmit continuous wave energy modulated with a code or pattern whose reflection can be discriminated in the received signal, thereby permitting the time of flight of the signal between the sensor and the underside of the trailer to be determined, and thus the distance. Since speed will depend on factors such as temperature and atmospheric pressure, it may be necessary to incorporate into the system at least one temperature sensor and/or atmospheric pressure sensor, and to program the control means to apply a correction factor according to the temperature and/or pressure detected.

Other forms of sensor may be used where the conditions permit, for example based on the reflection of radio waves. In a very simple arrangement, the sensors comprise hinged vertical probes which, when contacted by the underside of the trailer, are deflected. The deflection can be measured in a number of different ways, for example by a potentiometer attached to the hinge or pivot point for each probe. An image sensor or camera could be used in conjunction with an image recognition system to identify and located the king pin, for example. It would be possible for such a system to determine height relative to the tractor by, for example, assessing the image size of the king pin end. Alternatively, a pair of cameras could be used, deducing height from the relative image positions of the king pin end. Calibration markings could be provided underneath the trailer to assist in distance and position assessment.

Conveniently, the sensors are located on the chassis of the tractor, for example adjacent to, but below, either side of the entrance to the throat in the hitch plate. In this way, trailers having a relatively narrow width in the region of the king pin, for example fluid tankers, can be detected accurately. A correctly aligned king pin will pass between the sensors and not be detected by them. Sideways misalignment will result in one sensor detecting the end of the king pin, by virtue of its relative proximity to the sensor compared with the remainder of the underside of the trailer.

Additional sensors of the same general type may be provided at each side of the tractor vehicle to provide indications of the presence or absence of the trailer body above the additional sensors, thereby providing an earlier indication of misalignment of the tractor and trailer, especially where the trailer is a substantially flat-bottomed construction, for example a box-trailer. This will also permit detection of significant sideways error resulting in the king pin missing the entrance to the throat, and hence the throat sensors, altogether.

A further sensor may be located within or beneath the coupling socket to detect the presence of the king pin in the socket.

The system may include means for detecting the locked position of the hitch lock. This may simply comprise a proximity detector adjacent to a moving component of the locking mechanism such that proximity is only indicated when the mechanism is fully locked. Alternatively, the detector may be located in the mechanism so as to indicate the unlocked state thereof.

The system may be arranged to provide a visible and/or audible indication externally of the tractor as well as inside the tractor, especially in relation to the correct location and locking of the king pin in the hitch, so that others can be alerted of an error.

The audible indication, whether inside or outside the tractor, may consist of a pre-recorded or digitally-synthesised voice message, for example “TRAILER UNLOCKED”. Other audible indications may be used to guide the driver without his having to look at a visual display, for example to indicate misalignment.

In further embodiments, the system can be arranged to control the suspension height of the tractor automatically in response to the distance measurements detected, to ensure correct positioning. The coupling lock indicator signal may be used to actuate a solenoid in the parking brake air line for the trailer, closing the line and preventing the brakes from being released when the hitch lock is not correctly applied.

In one embodiment of the invention, at least one additional sensor is provided to measure the height of the tractor chassis above the ground. This may give an absolute measurement or a relative measurement. For example, a downward-facing ultrasonic sensor may be mounted on the tractor chassis. This could be focused on the ground or on a suspension component, such as an axle, which has a fixed relationship with the ground (although this would, of course, be dependent to some extent on tyre compression).

The advantage of measuring vehicle chassis height is that, with a configuration as described hereinbefore, when the tractor vehicle's suspension is raised so that the fifth wheel assembly on the tractor approaches the trailers rubbing plate, the sensor in front of the fifth-wheel measures a decreasing distance. After contact is made, further raising of the tractor suspension lifts the trailer, causing the measured distance in front of the fifth-wheel to start increasing again. By using the ground distance measurement, confirmation could be obtained that the tractor height is still increasing. This is desirable, because the same effect of increasing height measured in front of the fifth-wheel could also be given by lowering again after the moment of contact. Although it might be possible to achieve a similar effect by monitoring the changes in height detected by the sensor to the rear of the fifth-wheel assembly at the same time, generally the underside of the trailer at this location is less regular, and errors can therefore be introduced. While it might be possible to filter these out, the provision of ground measurement provides a simpler solution, and also affords the possibility of monitoring the overall vehicle height, for example.

In yet another embodiment of the invention, a sensor fixed to the back of the tractor cab could be configured to measure the horizontal distance between the rear of the cab and the front of the trailer. This could be useful in providing a warning for the driver if the distance is too small, giving rise to a risk of the trailer corners hitting the rear of the cab during turns. The exact minimum distance at which this risk arises depends on the position of the fifth-wheel (in some tractor vehicles the fifth-wheel assembly is adjustable in a fore-and-aft direction), and the distance of the king pin from the front of the trailer. It would be possible to configure the system of the invention to calculate these distances. This could be done by detecting the king pin as it passes over the rear sensor and at the same time recording the measurement of cab-to-trailer distance from the horizontal sensor on the cab rear. As the distance from the cab to the rear sensor is known, the distance of the king pin from the front of the trailer can be determined. When the king pin locks into the fifth-wheel, the cab-to-trailer distance can be added to the trailer front to king pin measurement to ascertain the actual position of the fifth-wheel pivot. Assuming a normal box type trailer, the corner clearance can then be measured and an alarm given if this is below predetermined limits.

Another aspect of the invention provides a system for monitoring the coupling of a tractor to a trailer of an articulated road vehicle, the tractor having a hitch lock associated with the hitch assembly and the trailer having landing legs which are raised to permit towing of the trailer and lowered to support the trailer when the tractor is uncoupled therefrom, the system comprising detector means for detecting the locked position of the hitch lock, locking means for preventing raising of the landing legs, and control means for receiving a signal from the detector means to indicate locking of the hitch lock and for releasing the landing leg locking means only in response to receipt of said signal.

Yet another aspect of the invention provides a system for monitoring the coupling of a tractor to a trailer of an articulated road vehicle, the tractor having a hitch lock associated with the hitch assembly and the trailer having parking brakes releasable by air pressure in a control line from the tractor to the trailer, the system comprising detector means for detecting the locked position of the hitch lock, a solenoid valve in the compressed air supply from the tractor to the trailer parking brakes, and control means for receiving a signal from the detector means to indicate locking of the hitch lock and for opening the solenoid valve only in response to receipt of said signal.

### BRIEF DESCRIPTION OF THE DRAWINGS

In the drawings, which illustrate an exemplary embodiment of the invention:

FIG. 1 is a diagrammatic top plan view of a tractor incorporating a system according to the invention;

FIG. 2 is an enlarged diagrammatic partial side elevation of the tractor of FIG. 1; and

FIG. 3 is a view corresponding to that of FIG. 1, showing an alterative arrangement.

### DETAILED DESCRIPTION OF THE ILLUSTRATED EMBODIMENT

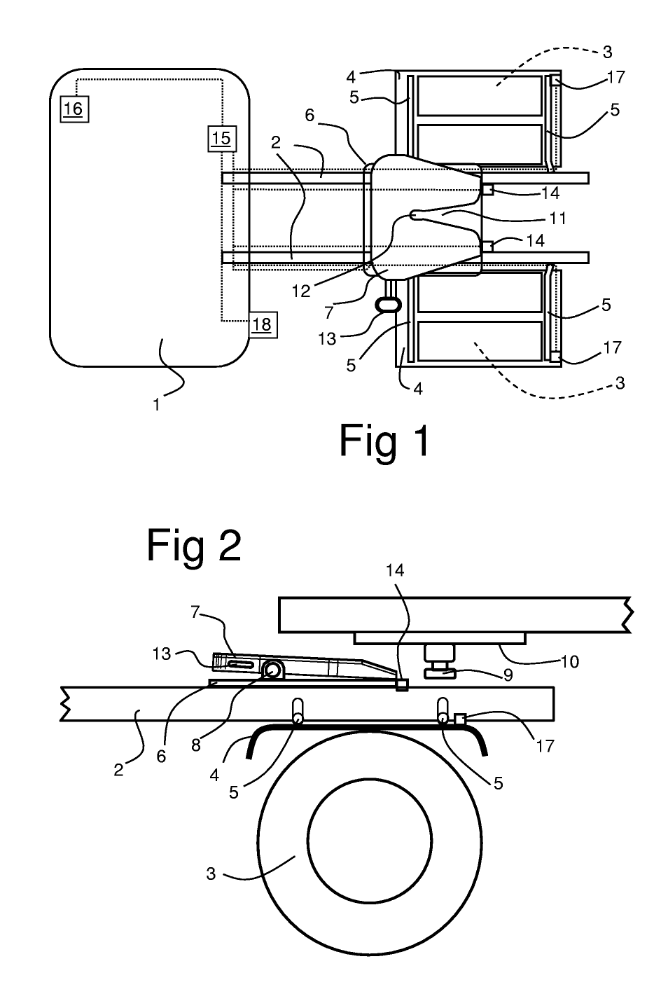

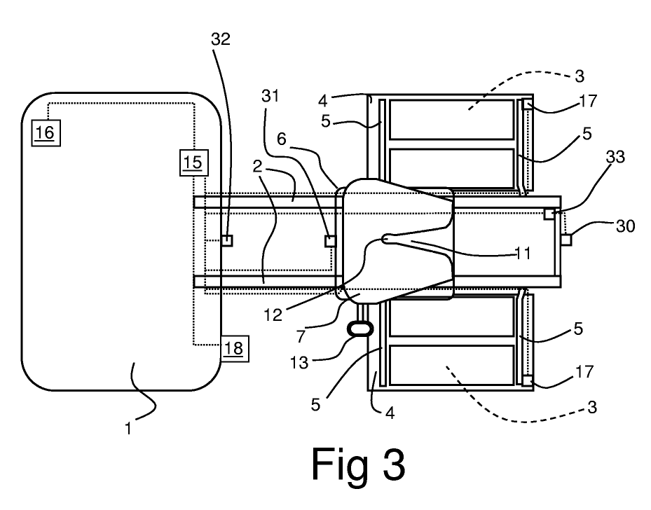

The drawings illustrate diagrammatically a typical articulated tractor and trailer unit, FIG. 1 showing the tractor and FIG. 2 showing a part of the tractor and a part of the trailer. The tractor is of conventional form and consists of a cab 1 at least partially located over the engine and transmission and front wheels, not shown. The tractor chassis has two main support beams 2 extending longitudinally and mounting the rear wheels 3. Enclosed wheel arches 4 are mounted over the wheels to contain spray and dirt. These are carried by mounting arms 5 extending from the beams 2.

The fifth wheel assembly comprises a mounting frame 6 attached to the beams 2 and carrying a hitch plate 7 pivotally mounted thereon by means of a transversely-extending pivot 8 so that the plate 7 can present an inclined surface to facilitate engagement of the king pin 9 on the underside of the trailer 10, as hereinafter described. The plate 7 has tapering slot 11 therein to guide the king pin laterally into a coupling socket 12 provided with a lock in conventional manner (not shown) to lock the king pin in position. The locking mechanism is unlocked by a release arm 13 extending out to one side of the fifth wheel assembly.

A first pair of ultrasonic sensors 14 is positioned on the chassis behind and below the hitch plate 7, one on each side of the centre-line of the tractor to flank the entrance to the tapering slot 11 in the hitch plate 7. The sensors 14 are configured to direct a narrow beam of acoustic energy vertically upwardly, detecting any of the ultrasound reflected back from a surface above, that is to say, the underside 10 of the trailer. The sensors 14 are connected to a controller 15 in the cab of the tractor, which is programmed to detect whether the underside of the trailer is detected by each of the sensors within a predetermined range above it. The controller 15 then provides signals to an indicator display device 16 adjacent to the driver within the cab to indicate, for example by means of suitable warning lights and/or sounds, that the trailer is within range and is over or under the desired distance above the tractor chassis, and also whether the alignment between the tractor and the trailer is correct; the absence of a signal on one side only indicates misalignment. A further indication can be given by detection of an abnormally small height from one of the sensors, showing that the king pin 9 is passing over the sensor.

A second pair of sensors 17 is positioned outwardly and rearwardly of the first sensors 14, one on each of the wheel arches 4 to give an additional, earlier, indication of misalignment of the tractor with the trailer, especially in the case of a flat-bed or box trailer. The second sensors 17 are also ultrasonic sensors directed upwardly, and are configured to detect the underside of the trailer at its lateral extremities before the king pin approaches the fifth wheel assembly. If one sensor 17 detects the underside of the trailer within an acceptable height range, while the other does not, the driver is given a misalignment indication on the display 16.

For correct detection of curved trailer bodies such as fluid tanker bodies, it may be possible to direct the second sensors 17 inwardly at an oblique angle to the vertical so that a reflected signal can be detected from the curved sides.

FIG. 3 illustrates a system with an alternative configuration of sensors, A first ultrasonic sensor 30 of the type described with reference to FIG. 1 is located on the centre line of the tractor vehicle, on the rearmost part of the chassis of the vehicle, and is directed vertically upwards. A second ultrasonic sensor 31, also on the centre line of the tractor, is mounted just in front of the hitch plate 7, and if the hitch plate assembly is slidable, it will be linked to it to slide with it. Each sensor is connected to the controller 15, as described hereinbefore.

In use, the system is also linked to the reversing light circuit of the tractor so that, when reverse gear is engaged prior to reversing the tractor to couple the trailer, the system can issue a warning to the driver, if no trailer is connected, to lower the suspension on the tractor in preparation for coupling the trailer. This can be done by a voice message, which also instructs the driver to reverse slowly until a warning beep is heard. The first sensor 30 detects the front of the underside of the trailer as it passes underneath, and this signal causes the system to emit an audible tone (“beep”) as a position indicator, and possibly a voice message telling the driver to stop at this point if the tractor suspension is detected to be too high relative to the trailer, so that the driver has an opportunity to lower the suspension further. In either case, a voice message will then tell the driver to reverse slowly until the next warning beep, and then stop.

The passage of the front edge of the trailer over the second sensor 31 generates a signal causing the system to produce an audible beep and a voice message telling the driver to stop and then raise the suspension. When the correct height is achieved, the system tells the driver to stop raising the suspension. The hitch plate or fifth wheel assembly 7 is now in contact with the rubbing plate 10 (FIG. 2) on the underside of the trailer, and the system then issues a voice instruction to the driver to reverse slowly until the king-pin locks in the fifth-wheel/hitch plate. The system monitors the lock status of the fifth-wheel as hereinafter described, and then informs the driver when a proper lock has been achieved and the vehicle is ready to drive forward.

The tractor may be provided with a rearwardly-directed ultrasonic sensor 32 on the rear of the cab to detect and measure the front of the trailer body, and a downwardly-directed sensor 33 at the rearmost part of the vehicle chassis to measure the vehicle chassis height above the ground in order to provide the indication of the lifting and lowering of the tractor suspension during the procedure described above. While this sensor is shown in FIG. 3 as a separately-mounted component, in practice it may be convenient to mount this in the same housing as the sensor 30.

The hitch lock may be provided with a suitable detector to provide a signal indicating whether or not the lock is engaged. The detector may be linked into the controller 15 to provide an indication on the display 16, and may additionally or alternatively be linked to a separate warning light 18 and/or buzzer on the outside of the cab or on the chassis, visible/audible to anyone positioned to the side of the vehicle to give a warning that the vehicle is about to be moved without the hitch lock being correctly engaged.

The hitch lock detector can also be connected electrically to a solenoid valve in the air line (not shown) connected between the tractor and the trailer to permit release of the trailer parking or spring brakes. These brakes are configured to be held on, preventing movement of the trailer, until air pressure is applied from the tractor to release them. The system may be configured to hold the solenoid valve closed until the hitch lock detector signals full engagement of the lock.

Additionally, or alternatively, an electrically-operated lock may be provided on the trailer landing legs, preventing them from being lifted until the hitch lock engagement signal has been received by the controller 15.

The hitch lock detector may be a micro switch engaged by a moving component of the lock, or a proximity detector, for example a magnetic proximity detector, adjacent to the engaged position of a component of the lock.

Additional sensors may be positioned within the slot 11 to give information about the position of the king pin relative thereto to assist in correct location of the pin in the coupling socket. A sensor may be located within or beneath the socket to give further confirmation of correct positioning.

In order to give confirmation of the situation where the king pin approaches the fifth wheel at the correct height, but laterally displaced from it, sensors may be mounted on the sides of the hitch plate directing a beam of ultrasound horizontally and laterally of the tractor.

1. A system for monitoring the coupling of a tractor to a trailer of an articulated road vehicle, the tractor mounting a hitch assembly for coupling to a king pin downwardly depending from the underside of the trailer, the system comprising a sensor producing an electrical signal proportional to the vertical distance between the hitch assembly and the underside of the trailer, and indicator means connected to the sensor for providing an indication of the vertical distance.

2. A system according to claim 1, comprising a pair of the sensors mounted on the tractor and laterally spaced one from the other relative to the direction of travel of the vehicle.

3. A system according to claim 2, wherein the sensors are located to the rear of the hitch assembly on the tractor, one on each side of the centre-line of the tractor.

4. A system according to claim 1, comprising first and second sensors mounted on the centre line of the tractor, the first located at the rearmost part of the tractor, and the second just in front of the hitch assembly.

5. A system according to claim 1, comprising an upwardly-directed sensor at each side of the tractor vehicle to detect the presence or absence of the trailer thereabove, thereby indicating correct or incorrect alignment of the trailer and tractor.

6. A system according to claim 2, wherein the indicator means include a controller arranged to compare the respective signals and to output signals to an indicator device mounted in the tractor adjacent to the driver thereof to provide visual and/or audible indications when one of the following conditions applies:
a) the said vertical distance is not within a predetermined range; and
b) the difference between the vertical distances detected by the two sensors is greater than a predetermined value.

7. A system according to claim 6, wherein the controller is arranged to provide voice messages and/or visual indications to guide a driver of the tractor vehicle during coupling of the trailer to the tractor, in response to said signals.

8. A system according to claim 1, wherein the tractor comprises variable-height suspension, and the system also comprises a downwardly-directed sensor mounted on the tractor to measure the distance from the ground.

9. A system according to claim 1, wherein the tractor has a cab mounting on the rear face thereof a horizontally and rearwardly directed sensor to measure the distance from the front face of the trailer.

10. A system according to claim 1, wherein the or each sensor comprises an ultrasonic transmitter arranged to transmit acoustic energy upwardly and an associated ultrasonic receiver to detect the energy reflected back from a surface above the sensor.

11. (canceled)

12. A system according to claim 10, wherein the transmitter and receiver are separate devices spaced one from the other.

13. A system according to claim 10, wherein the transmitters are arranged to transmit brief pulses of acoustic energy, the time interval between adjacent pulses being sufficient for the associated receiver to detect the reflected energy.

14. A system according to claim 1, wherein a further sensor is located within or beneath the coupling socket to detect the presence of the king pin therein.

15. A system according to claim 1, wherein the tractor has a hitch lock associated with the hitch assembly, and the system comprises means for detecting the locked position of the hitch lock.

16. A system according to claim 15, wherein the means for detecting the locked position of the hitch lock comprises a proximity detector positioned adjacent to a movable component of the hitch lock.

17. A system according to claim 15, wherein the control means is linked to a solenoid valve in the compressed air supply from the tractor to the trailer parking brakes, and is arranged to hold the valve closed, thereby preventing release of the trailer parking brakes, until the means for detecting the locked position of the hitch lock signals that the hitch lock is locked.

18. A system according to claim 1, comprising additional visible and/or audible warning means outside the tractor vehicle and connected to the control means for indicating the unlocked state of the hitch lock mechanism.

19. A system according to claim 1, wherein the control means is linked to the tractor suspension control to control the height of the tractor hitch assembly relative to the trailer automatically in response to the distance detected by the sensors.

20. A system for monitoring the coupling of a tractor to a trailer of an articulated road vehicle, the tractor having a hitch lock associated with the hitch assembly and the trailer having landing legs which are raised to permit towing of the trailer and lowered to support the trailer when the tractor is uncoupled therefrom, the system comprising detector means for detecting the locked position of the hitch lock, locking means for preventing raising of the landing legs, and control means for receiving a signal from the detector means to indicate locking of the hitch lock and for releasing the landing leg locking means only in response to receipt of said signal.

21. A system for monitoring the coupling of a tractor to a trailer of an articulated road vehicle, the tractor having a hitch lock associated with the hitch assembly and the trailer having parking brakes releasable by air pressure in a control line from the tractor to the trailer, the system comprising detector means for detecting the locked position of the hitch lock, a solenoid valve in the compressed air supply from the tractor to the trailer parking brakes, and control means for receiving a signal from the detector means to indicate locking of the hitch lock and for opening the solenoid valve only in response to receipt of said signal.
